(19) United States
(12) Patent Application Publication
(10) Pub. No.: US 2002/0194217 A1
(43) Pub. Date: Dec. 19, 2002

(54) Metadata graphial user interface

(75) Inventors: Richard D. Hoffman, Austin, TX (US); Michael A. Perks, Austin, TX (US); Sean Michael Sundberg, Waco, TX (US)

Correspondence Address: Frank C. Nicholas, CARDINAL LAW GROUP, Suite 2000, 1603 Orrington Avenue, Evanston, IL, 60201, US

(73) Assignee: International Business Machnies Corporation, Armonk, NY

(21) Appl. No.: 09/843,068

(22) Filed: Apr. 26, 2001

(51) Int. Cl. G06F 15/00

(52) U.S. Cl. 707/503; 707/523

(57) ABSTRACT

A computer for implementing a method for generating metadata objects is disclosed. A graphical user interface of the computer displays a spreadsheet including metadata information and/or metadata directives. The graphical user interface further provides a command to convert the spreadsheet into a comma separated value file. Upon a conversion of the spreadsheet to the comma separated value file, the metadata information therein is parsed in accordance with any metadata directives therein to thereby generate the metadata objects.

### BACKGROUND OF THE INVENTION

1. Field of the Invention

The present invention generally relates to the generation of metadata objects (i.e., data for describing data objects). The present invention specifically relates to a graphical user interface for facilitating the development and modification of metadata. In the context of the present invention, metadata objects may refer to instances of classes persisted to a file, relational or object-oriented database or simply rows in tables in a relational database.

2. Description of the Related Art

Data driven programs known in the art import data objects associated metadata objects from files or databases. The development of the metadata objects is typically accomplished by one of two methods. The first method entails a direct creation and storage of data objects and associated metadata objects on file(s) or in database(s). This method suffers from two major drawbacks. First, an inordinate amount of time is normally required to create the data objects and the metadata objects. Second, the metadata objects as stored are not easily modifiable.

The second method entails a programming of a customized graphical user interface for generating and storing the data objects and associated metadata objects on file(s) or in database(s). This method suffers from a drawback of the complexity and effort of programming a customized graphical user interface.

What is therefore needed is a method and a computer for facilitating the development and modification of metadata objects.

### SUMMARY OF THE INVENTION

The present invention relates to a metadata graphical user interface that overcomes the disadvantages associated with the prior art. Various aspects of the invention are novel and non-obvious. While the actual nature of the present invention covered herein can only be determined with reference to the claims appended hereto, certain features, which are characteristic of the embodiments disclosed herein, are described briefly as follows.

One form of the present invention is a method for generating metadata objects. A spreadsheet including metadata information is displayed, and a command for triggering a conversion of the metadata information into a comma separated value file is provided.

A second form of the present invention is a computer for generating metadata objects. The computer comprises means for displaying a spreadsheet including metadata information, and means for providing a command to trigger a conversion of the metadata information into a comma separated value file.

A third form of the present invention is a computer program product in a computer readable medium for generating metadata objects. The computer program product comprises computer readable code for displaying a spreadsheet including metadata information, and computer readable code for providing a command to trigger a conversion of the metadata information into a comma separated value file.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of one embodiment in accordance with the present invention of computer hardware employed in the present invention;

FIG. 2 is a block diagram of one embodiment in accordance with the present invention of computer software employed in the present invention;

FIG. 3 is a flow chart of one embodiment of a metadata object generation routine implemented by the FIG. 1 computer hardware and the FIG. 2 computer software; and

FIG. 4 is an exemplary worksheet including a metadata directive column and a metadata information grid.

### DETAILED DESCRIPTION OF THE PRESENTLY PREFERRED EMBODIMENTS

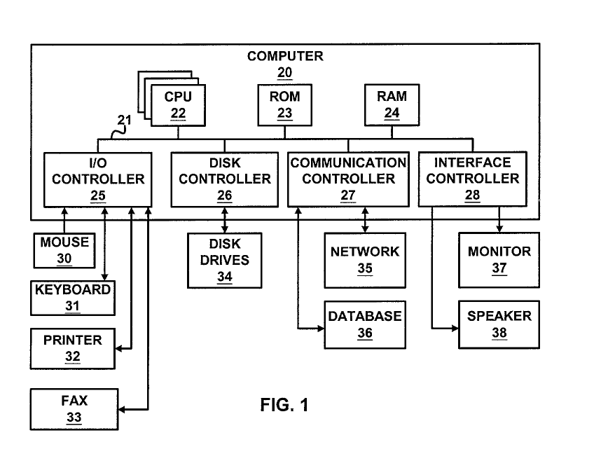

A computer 20 of the present invention is shown in FIG. 1. Referring to FIG. 1, computer 20 may be configured in any form for accepting structured inputs, processing the inputs in accordance with prescribed rules, and outputting the processing results as would occur to those having ordinary skill in the art, such as, for example, a personal computer, a workstation, a super computer, a mainframe computer, a minicomputer, a super minicomputer, or a microcomputer. Computer 20 preferably includes a bus 21 for facilitating electrical communication among one or more central processing units (CPU) 22, a read-only memory (ROM) 23, a random access memory (RAM) 24, an input/output (I/O) controller 25, a disk controller 26, a communication controller 27, and a user interface controller 28.

Each CPU 22 is preferably one of the Intel families of microprocessors, one of the AMD families of microprocessors, one of the Motorola families of microprocessors, or one of the various versions of a Reduced Instruction Set Computer microprocessor such as the PowerPC chip manufactured by IBM. ROM 23 stores controlling programs for operating controllers 25-28, such as, for example, the Basic Input-Output Computer (BIOS) developed by IBM. RAM 24 is the memory for loading an operating computer and selectively loading application programs.

Controller 25 is an aggregate of controllers for facilitating an interaction between each CPU 22 and pointing devices such as a mouse 30 and a keyboard 31, and between each CPU 22 and output devices such as a printer 32 and a fax 33. Controller 26 is an aggregate of controllers for facilitating an interaction between each CPU 22 and data storage devices such as disks drives 34 in the form of a hard drive, a floppy drive, and a compact-disc drive. The hard drive stores a conventional operating computer, such as, for example, IBM's AIX operating computer or OS/2 operating computer, and application programs.

Controller 27 is an aggregate of controllers for facilitating an interaction between each CPU 22 and a network 35, and between CPU 22 and an external database 36. Controller 28 is an aggregate of controllers for facilitating an interaction between each CPU 22 and a graphic display device such as a monitor 37, and between each CPU 22 and an audio device such as a speaker 38.

Those having skill in the art will appreciate alternative embodiments of a computer, particularly other embodiments of computer 20, for implementing the principles of the present invention.

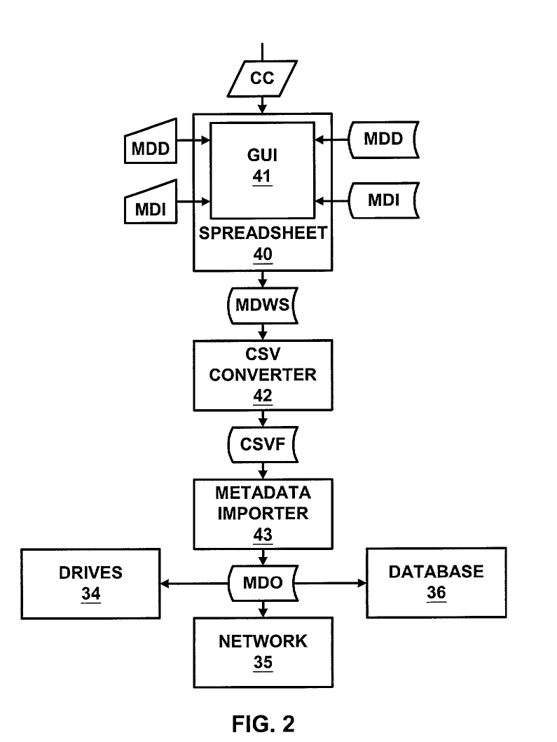

Referring additionally to FIG. 2, a spreadsheet program 40, a comma separated value (CSV) converter 42, and a metadata importer 43 are computer programs physically stored within the hard drive and uploaded to RAM 23 whereby the hard drive and RAM 22 are computer readable mediums that electrically, magnetically, optically or chemically altered to carry computer readable information. Concurrently or alternatively, spreadsheet program 40, CSV converter 42, and metadata importer 43 can be stored in other computer readable mediums of computer 20 (e.g., the CD-ROM drive of hard drives 34), or in a memory of another computer whereby spreadsheet program 40, CSV converter 42, and metadata importer 43 can be accessed via network 35. In other embodiments, spreadsheet program 40, CSV converter 42, and metadata importer 43 can be partially or fully implemented with digital circuitry, analog circuitry, or both.

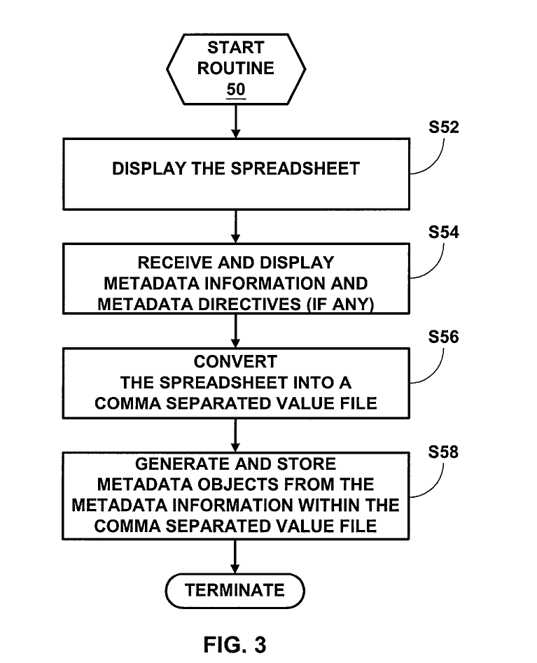

Referring additionally to FIG. 3, a metadata object generation routine 50 as implemented by spreadsheet program 40, CSV converter 42, and metadata importer 43 will now be described herein. While the implementation of routine 50 is described by a descriptive interaction of spreadsheet 40, CSV converter 42, and metadata importer 43 in terms of data transfers, those having ordinary skill in the art will appreciate the physical elements of computer 20 that are associated with the implementation of routine 50.

During a stage S52 of routine 50, a graphical user interface (GUI) 41 of spreadsheet program 40 displays a spreadsheet including one or more worksheets on monitor 37. Each worksheet supports the standard spreadsheet user interface metaphor (e.g., cells, values, etc.) and is exportable into a comma separated value (CSV) format. Additionally, each worksheet can support cell formulas and cell references. In one embodiment, spreadsheet program 40 is a version of the EXCEL spreadsheet program from Microsoft Corporation that has been modified to include GUI 41 under the principles of the present invention.

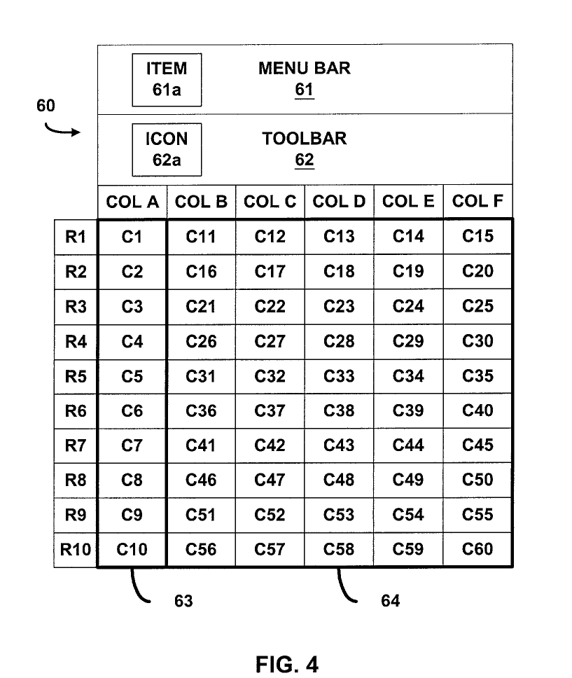

An exemplary display of a worksheet 60 is shown in FIG. 4. Referring to FIG. 4, worksheet 60 includes a menu bar 61, a toolbar 62, a metadata directive column 63, and a metadata information grid 64. Menu bar 61 has a menu item 60a and toolbar 62 has an icon 62a. Menu item 61a and icon 62a are for selectively activating CVS converter 42 as will be subsequently described herein in connection with a stage S56 of routine 50. Metadata directive column 63 includes cells C1-C10 for displaying inputted metadata directives MDD as will be subsequently described herein in connection with a stage S54 of routine 50. Metadata information grid 64 includes cells C11-C60 for displaying inputted metadata information MDI as will be subsequently described herein in connection with stage S54 of routine 50. Metadata directive column 63 and metadata information grid 64 are vertically aligned along rows R1-R10 with metadata directive column 63 being displayed under column COL A and metadata information grid 64 being displayed under columns COL B-COL F. Alternatively, metadata directive column 63 can be inserted within or positioned after metadata information grid 64; or metadata direction column 62 can be omitted with metadata directives inserted within metadata information grid 64.

Referring to FIGS. 1-4, during stage S54 of routine 50, spreadsheet program 40 conventionally receives metadata information MDI from a user of computer 20 via keyboard 31 or a storage device such as one of the disk drives 34, and GUI 41 inputs the metadata information MDI in corresponding cells of a displayed worksheet. For example, when worksheet 60 is displayed is displayed on monitor 37, GUI 41 displays metadata information MDI in each cell of cells C1-C60 of metadata information grid 64 that corresponds to the input of the metadata information MDI.

Metadata directives MDD are storage instructions for metadata importer 43 as will be subsequently described herein in connection with stage S58 of routine 50. The following TABLE 1 includes exemplary metadata directives MDD with a corresponding name, syntax and function:

TABLE 1

| METADATA | | | |
|---|---|---|---|
| DIRECTIVE | NAME | SYNTAX | FUNCTION |
| * | Comment | * <comment> | Remainder of row |
| | | | is ignored. |
| K | Copy | K LIST >list1> FROM | Copy all of the |
| | | LIST <list2> | elements of list2 |
| | | | to list1. |
| M | Mandate | M SIZE <list1> = SIZE | Generate a |
| | | <list2 > | warning if the |
| | | | lengths of list 1 |
| | | | and list 2 are not |
| | | | the same. |
| R | Replace | R LIST <list> | Make <element> |
| | | POSITION <n> | the nth element |
| | | ELEMENT <element> | in <list>. |
| S | Sort | S<list> | Sort <list> |
| | | | according to |
| | | | display text of |
| | | | its elements. |
| X | End | X | Marks last row of |
| | | | metadata |
| | | | information. |

When metadata importer 43 is designed to follow metadata directives MDD, spreadsheet program 40 will receive any input of one or more metadata directives MDD from a user of computer 20 or a storage device such as one of the disk drives 34, and GUI 41 displays the metadata directive(s) MDD in corresponding cell(s) of a displayed worksheet. For example, when worksheet 60 is displayed on monitor 37, GUI 41 displays metadata directives MDD in each cell of cells C1-C10 of metadata directive column 63 that corresponds to the input of the metadata directives MDD.

During stage S56 of routine 50, in response to a conversion command CC, CVS converter 42 conventionally converts the displayed spreadsheet into a comma separated value file CSVF. In one embodiment, a end of line marker is placed in the last column of every row in the worksheet to ensure that the correct number of commas are written into the comma separated value file CSVF. For example, when worksheet 60 is displayed on monitor 37, a user of computer 20 can use mouse 30 to sort through menu item 61 a or activate icon item 62a to thereby provide conversion command CC to converter 42. The following TABLE 2 illustrates the contents of each line of comma separated value file CSVF when worksheet 60 is displayed:

TABLE 2

| LINE | CONTENTS |
|---|---|
| 1 | C1, C11, C12, C13, C14, C15 |
| 2 | C2, C16, C17, C18, C19, C20 |
| 3 | C3, C21, C22, C23, C24, C25 |
| 4 | C4, C26, C27, C28, C29, C30 |
| 5 | C5, C31, C32, C33, C34, C35 |
| 6 | C6, C36, C37, C38, C39, C40 |
| 7 | C7, C41, C42, C43, C44, C45 |
| 8 | C8, C46, C47, C48, C49, C50 |
| 9 | C9, C51, C52, C53, C54, C55 |
| 10 | C10, C56, C57, C58, C59, C60 |

During stage S58 of routine 50, metadata importer 43 conventionally generates metadata objects MDO from the metadata information MDI within comma separated value file CSVF and stores the metadata objects MDO within one of disk drives 34, a data storage device accessible through network 35, or database 36. In one embodiment, when only metadata information MDI is within comma separated value file CSVF, importer 43 is programmed to parse the comma separated value file CSVF to thereby generate the metadata objects MDO. In an alternative embodiment, when metadata information MDI and metadata directives MDD are within comma separated value file CSVF, importer 43 is programmed to identify the metadata directives MDD within comma separated value file CSVF and to parse metadata information MDI within comma separated value file CSV in accordance with the metadata directives MDD to thereby generate the metadata objects MDO.

Routine 50 is terminated upon completion of stage S58. Subsequently, the spreadsheet including the metadata information MDI and/or metadata directives MDD can be stored for future modifications.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for generating metadata objects, said method comprising:
displaying a spreadsheet including metadata information therein; and
providing a command to trigger a conversion of the spreadsheet into a comma separated value file.

2. The method of claim 1, further comprising:
converting the spreadsheet into the comma separated value file in response to an activation of the command; and
parsing the comma separated value file to thereby generate the metadata objects from the metadata information.

3. The method of claim 1, further comprising:
inputting the metadata information into the spreadsheet in response to a reception of the metadata information.

4. A method for generating metadata objects, said method comprising:
displaying a spreadsheet including metadata information and one or more metadata directives therein; and
providing a command to trigger a conversion of the spreadsheet into a comma separated value file.

5. The method of claim 4, further comprising:
converting the spreadsheet into the comma separated value file in response to an activation of the command; and
parsing the comma separated value file in accordance with the one or more metadata directives to thereby generate the metadata objects from the metadata information.

6. The method of claim 4, further comprising:
inputting the metadata information into the spreadsheet in response to a reception of the metadata information; and
inputting the one or more metadata directives into the spreadsheet in response to a reception of the one or more metadata directives.

7. A computer for generating metadata objects, said computer comprising:
means for displaying a spreadsheet including metadata information therein; and
means for providing a command to trigger a conversion of the spreadsheet into a comma separated value file.

8. The computer of claim 7, further comprising:
means for converting the spreadsheet into the comma separated value file in response to an activation of the command; and
means for parsing the comma separated value file to thereby generate the metadata objects from the metadata information.

9. The computer of claim 7, further comprising:
means for inputting the metadata information into the spreadsheet in response to a reception of the metadata information.

10. A computer for generating metadata objects, said computer comprising:
means for displaying a spreadsheet including metadata information and one or more metadata directives therein; and
means for providing a command to trigger a conversion of the spreadsheet into a comma separated value file.

11. The method of claim 10, further comprising:
means for converting the spreadsheet into the comma separated value file in response to an activation of the command; and
means for parsing the comma separated value file in accordance with the one or more metadata directives to thereby generate the metadata objects from the metadata information.

12. The method of claim 10, further comprising:
means for inputting the metadata information into the spreadsheet in response to a reception of the metadata information; and
means for inputting the one or more metadata directives into the spreadsheet in response to a reception of the one or more metadata directives.

13. A computer program product in a computer readable medium for generating metadata objects, said computer program product comprising:
computer readable code for displaying a spreadsheet including metadata information therein; and
computer readable code for providing a command to trigger a conversion of the spreadsheet into a comma separated value file.

14. The computer program product of claim 13, further comprising:
computer readable code for converting the spreadsheet into the comma separated value file in response to an activation of the command; and
computer readable code for parsing the comma separated value file to thereby generate the metadata objects from the metadata information.

15. The computer program product of claim 13, further comprising:
computer readable code for inputting the metadata information into the spreadsheet in response to a reception of the metadata information.

16. A computer program product in a computer readable medium for generating metadata objects, said computer program product comprising:
computer readable code for displaying a spreadsheet including metadata information and one or more metadata directives therein; and
computer readable code for providing a command to trigger a conversion of the spreadsheet into a comma separated value file.

17. The method of claim 16, further comprising:
computer readable code for converting the spreadsheet into the comma separated value file in response to an activation of the command; and
computer readable code for parsing the comma separated value file in accordance with the one or more metadata directives to thereby generate the metadata objects from the metadata information.

18. The method of claim 16, further comprising:
computer readable code for inputting the metadata information into the spreadsheet in response to a reception of the metadata information; and
computer readable code for inputting the one or more metadata directives into the spreadsheet in response to a reception of the one or more metadata directives.
